(19) United States
(12) Patent Application Publication
(10) Pub. No.: US 2018/0356680 A1
(43) Pub. Date: Dec. 13, 2018

(54) POLARIZER ATTACHING QUALITY DETECTION SYSTEM AND METHOD

(71) Applicants: HKC Corporation Limited, Shenzhen City, Guangdong (CN); Chongqing HKC Optoelectronics Technology Corporation Limited, Chongqing (CN)

(72) Inventor: Chun-Chin HUANG, Chongqing (CN)

(21) Appl. No.: 15/536,997

(22) PCT Filed: Feb. 26, 2017
(86) PCT No.: PCT/CN2017/074912

§ 371 Date: Jun. 16, 2017

(30) Foreign Application Priority Data
Dec. 28, 2016 (CN) 201611237418.X

(51) Int. Cl. G02F 1/1335; G01M 11/08; G02B 5/30

(52) U.S. Cl. CPC G02F 1/133528; G02F 1/1303; G02B 5/3025; G01M 11/08

(57) ABSTRACT

This application relates to a polarizer attaching quality detection system and method. The system includes: an attaching unit, configured to attach a polarizer to a surface of a liquid crystal panel; a pressurization defoaming unit, configured to pressurize the polarizer attached by the attaching unit on the surface of the liquid crystal panel; an attaching quality detection unit, configured to detect whether the polarizer is closely attached to the surface of the liquid crystal panel; a reprocessing attaching machine unit, configured to: re-attach the polarizer to the surface of the liquid crystal panel when the polarizer is not closely attached to the surface of the liquid crystal panel; and a conveyor line, connected to the attaching unit, the pressurization defoaming unit, the attaching quality detection unit, and the reprocessing attaching machine unit, wherein the conveyor line is configured to convey the polarizer and the liquid crystal panel.

### TECHNICAL FIELD

This application relates to a quality detection method, and in particular, to a polarizer attaching quality detection system and method.

### RELATED ART

Generally, a liquid crystal display panel is formed by a color filter (CF), a thin film transistor array substrate (TFT Array Substrate), and a liquid crystal layer disposed between the two substrates. A working principle of the liquid crystal display panel is that rotation of liquid crystal molecules of the liquid crystal layer are controlled by applying a driving voltage to two glass substrates, and light rays of a backlight module are refracted to generate an image. According to different orientation manners of liquid crystals, liquid crystal display panels on the current mainstream market may be classified into the following types: a vertical alignment (VA) type, a twisted nematic (TN) type, a super twisted nematic (STN) type, an in-plane switching (IPS) type, and a fringe field switching (FFS) type.

In a liquid crystal display, a polarizer is one of indispensable components. The polarizer is configured to polarize light rays that originally have no polarity into polarized light. Therefore, the liquid crystal display can control passing, of light rays and presentation of color signals by using the polarized light and intrinsic twisted features of liquid crystal molecules. Moreover, in recent years, as liquid crystal display components are widely applied to various electronic devices such as word processors, computer screens, mobile phones, or liquid crystal televisions, there is a growing demand for polarizers. Therefore, how to improve efficiency of a manufacturing process and reduce steps of the manufacturing process is a management problem that business operators need to deal with.

### SUMMARY

To resolve the foregoing technical problem, an objective of this application is to provide a quality detection method, and in particular, this application relates to a polarizer attaching quality detection system and method, so as to not only effectively simplify a polarizer re-processing flow and easily and systematically manage ledger materials of re-processed products, but also reduce investment costs of devices.

The objective of this application is achieved and the technical problem of the present application is resolved by using the following technical solution. According to this application, a polarizer attaching quality detection system is provided, comprising: an attaching unit, configured to attach a polarizer to a surface of a liquid crystal panel; a pressurization defoaming unit, configured to pressurize the polarizer attached by the attaching unit on the surface of the liquid crystal panel; an attaching quality detection unit, configured to detect whether the polarizer is closely attached to the surface of the liquid crystal panel; a reprocessing attaching machine unit, configured to: re-attach the polarizer to the surface of the liquid crystal panel when the polarizer is not closely attached to the surface of the liquid crystal panel; and a conveyor line, connected to the attaching unit, the pressurization defoaming unit, the attaching quality detection unit, and the reprocessing attaching machine unit, and the conveyor line is configured to convey the polarizer and the liquid crystal panel, where the polarizer re-attached by the reprocessing attaching machine unit is pressurized on the surface of the liquid crystal panel by using the same pressurization defoaming unit.

The objective of this application may also be further achieved and the technical problem of the present application may also be further resolved by using the following technical measure.

A polarizer attaching quality detection method comprises: attaching a polarizer to a surface of a liquid crystal panel; pressurizing the attached polarizer on the surface of the liquid crystal panel by using a pressurization defoaming unit; detecting whether the polarizer is closely attached to the surface of the liquid crystal panel, and when the polarizer is not closely attached to the surface of the liquid crystal panel, re-attaching the polarizer to the surface of the liquid crystal panel; and pressurizing the re-attached polarizer on the surface of the liquid crystal panel by using the same pressurization defoaming unit.

In an embodiment of this application, the polarizer attaching quality detection system can further comprise a cleaning unit connected to the conveyor line and configured to clean the polarizer.

In an embodiment of this application, according to the polarizer attaching quality detection system, a material of the polarizer is any one selected from a group consisting of an iodine polarizing material, a dye polarizing material, and a metal polarizing material.

In an embodiment of this application, according to the polarizer attaching quality detection system, a material of the polarizer may be polyvinyl alcohol.

In an embodiment of this application, according to the polarizer attaching quality detection method, the detecting whether the polarizer is closely attached to the surface of the liquid crystal panel comprises: when the polarizer is closely attached to the surface of the liquid crystal panel, performing a packaging and delivering process.

In an embodiment of this application, the polarizer attaching quality detection method further comprises: before the step of attaching a polarizer to a surface of a liquid crystal panel, cleaning the polarizer.

In an embodiment of this application, according to the polarizer attaching quality detection method, the step of pressurizing the re-attached polarizer on the surface of the liquid crystal panel by using, the same pressurization defoaming unit comprises: performing a manual feeding step, pressurizing and defoaming the polarizer, and performing a manual discharging step.

In an embodiment of this application, according to the polarizer attaching quality detection method, the step of pressurizing the attached polarizer on the surface of the liquid crystal panel by using the pressurization defoaming unit comprises: performing an automatic feeding step, pressurizing and defoaming the polarizer, and performing an automatic discharging step.

In an embodiment of this application, according to the polarizer attaching quality detection method, a product ledger material increased with the re-attachment of the polarizer to the surface of the liquid crystal panel needs to undergo a data comparison with a database.

In this application, not only a polarizer re-processing flow can be effectively simplified, and ledger materials of re-processed products are easily and systematically managed, but also investment costs of devices are reduced.

### BRIEF DESCRIPTION OF THE DRAWINGS

FIG. 1a is a structural sectional view of an exemplary polarizer;

FIG. 1b is a flowchart of exemplary polarizer attaching quality detection;

FIG. 2 is a flowchart of polarizer attaching quality detection according to this application; and

FIG. 3 is a flowchart of a manual port in polarizer attaching quality detection according to this application.

### DETAILED DESCRIPTION

The following embodiments are described with reference to the accompanying drawings, which are used to exemplify specific embodiments for implementation of this application. Terms about directions mentioned in this application, such as “on”, “below”, “front”, “back”, “left”, “right”, “in”, “out”, and “side surface” merely refer to directions of the accompanying drawings. Therefore, the used terms about directions are used to describe and understand this application, and are not intended to limit this application.

The accompanying drawings and the description are considered to be essentially exemplary, rather than limitative. In figures, units with similar structures are represented by using a same reference number. In addition, for understanding and ease of description, a size and a thickness of each component shown in the accompanying drawings are arbitrarily shown, but this application is not limited thereto.

In the accompanying drawings, for clarity, thicknesses of a layer, a film, a panel, an area, and the like are enlarged. In the accompanying drawings, for understanding and ease of description, thicknesses of some layers and areas are enlarged. It should be understood that when a component such as a layer, a film, an area, or a substrate is described to be “on” “another component”, the component may be directly on the another component, or there may be an intermediate component.

In addition, in this specification, unless otherwise explicitly described to have an opposite meaning, the word “include” is understood as including the component, but not excluding any other component, In addition, in this specification, “on” means that a component is located on or below a target component, but does not mean that the component needs to be located on top of a gravity direction.

To further describe the technical means adopted in this application to achieve the present invention objective and effects thereof, specific implementations, structures, features, and effects of a polarizer attaching quality detection system and method provided according to this application are described in detail below with reference to the drawings and preferred embodiments.

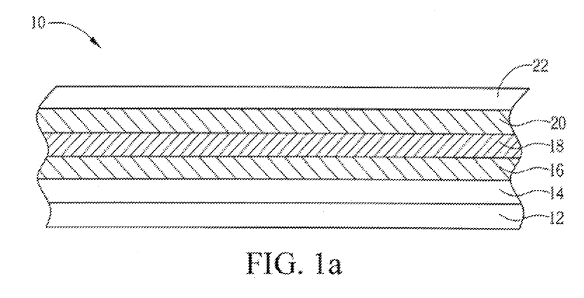

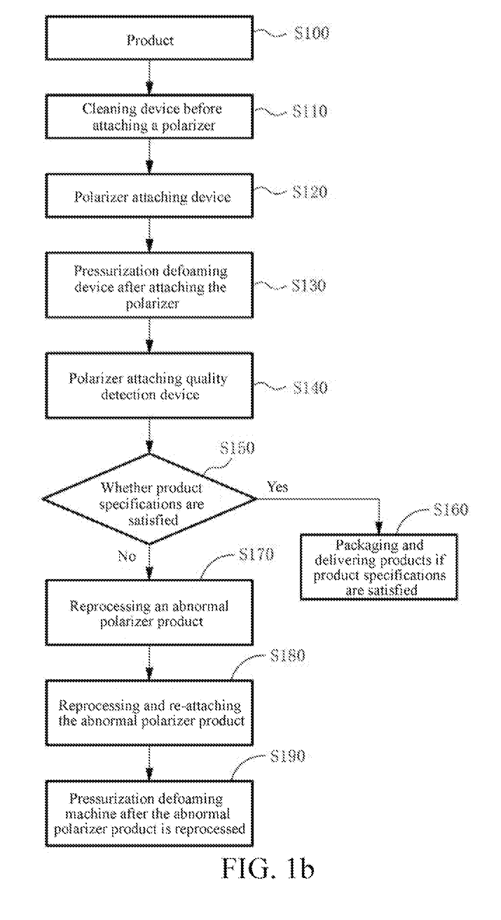

A sectional structure a polarizer 10 is shown in FIG. 1a. The polarizer 10 can include a release film 12, a pressure sensitive adhesive layer 14, a polyvinyl alcohol (PVA for short below) polarizing matrix layer 18, triacetyl cellulose (TAC for short below) support films 16 and 20, and a protection film 22. To avoid a reflection phenomenon, special processing may be further performed on a surface of a polarizing film. For example, an anti-glare layer or an anti-reflection layer is added to the surface of the polarizing film. Currently, mainstream polarizers on the market are iodine polarizers for the following reasons. The iodine polarizers have high optical penetrability, high contrast ratios, and a polarizing feature with relatively wide domain wavelengths. The iodine polarizers are relatively easy to be manufactured, and prices thereof are also relatively low.

FIG. 1b is a flowchart of exemplary polarizer attaching quality detection. Referring to FIG. 1b, a polarizer attaching quality detection method includes: S100: providing a liquid crystal panel product; S110: cleaning a polarizer before attaching the polarizer to the liquid crystal panel; S120: attaching the cleaned polarizer to a surface of the liquid crystal panel; S130: performing pressurization defoaming the polarizer attached to the surface of the liquid crystal panel; S140: detecting whether the polarizer attached to the surface of the liquid crystal panel is closely attached to the surface of the liquid crystal panel; S150: determining whether the polarizer satisfies product specifications; S160: if the polarizer is closely attached to the surface of the liquid crystal panel, performing packaging and delivering; S170: if the polarizer is not closely attached to the surface of the liquid crystal panel or the polarizer is an abnormal product, re-processing the polarizer; S180: after the abnormal product of the polarizer is re-processed; and S190: performing a manufacturing process by using a pressurization defoaming machine.

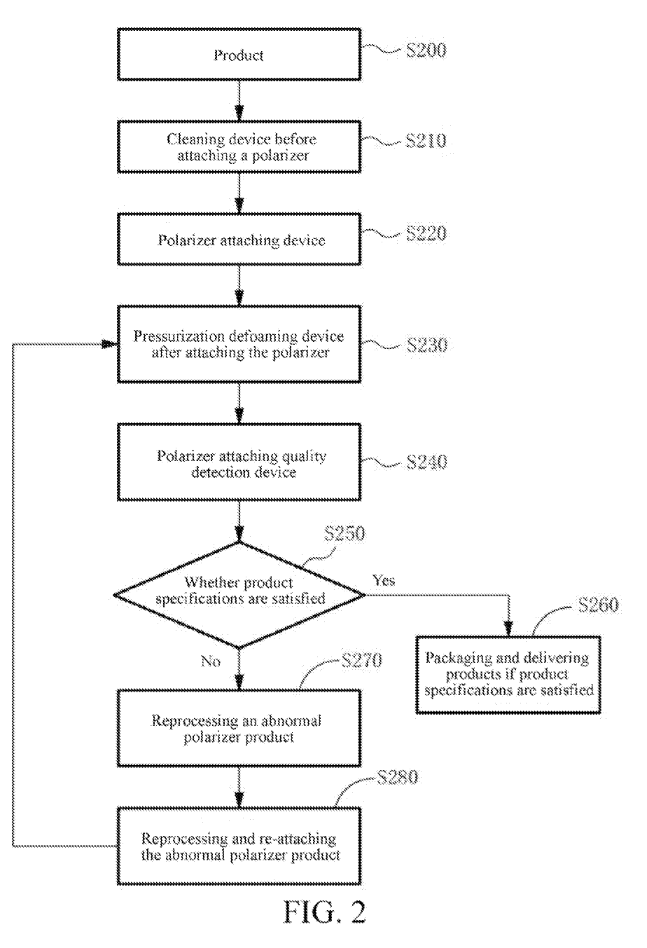

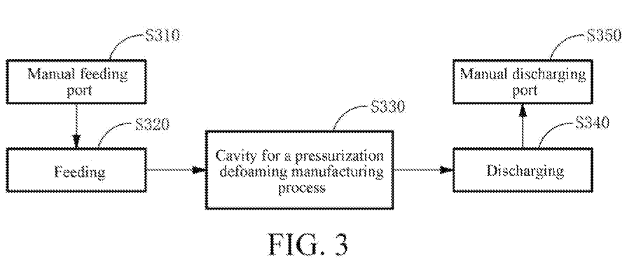

FIG. 2 is a flowchart of polarizer attaching quality detection according to this application; and FIG. 3 is a flowchart of a manual port in polarizer attaching quality detection according to this application. Referring to FIG. 2 and FIG. 3, in an embodiment of this application, a polarizer attaching quality detection system of this application includes an attaching unit, a pressurization defoaming unit, an attaching quality detection unit, a reprocessing attaching machine unit, and a conveyor line. The attaching unit is configured to attach a polarizer to a surface of a liquid crystal panel; the pressurization defoarning unit is configured to pressurize the polarizer attached by the attaching unit on the surface of the liquid crystal panel; the attaching quality detection unit is configured to detect whether the polarizer is closely attached to the surface of the liquid crystal panel; the reprocessing attaching machine unit is configured to: re-attach the polarizer to the surface of the liquid crystal panel when the polarizer is not closely attached to the surface of the liquid crystal panel; and the conveyor line is connected to the attaching unit, the pressurization defoaming unit, the attaching quality detection unit, and the reprocessing attaching machine unit and is configured to convey the polarizer and the liquid crystal panel, where the polarizer attached by the reprocessing attaching machine unit is pressurized on the surface of the liquid crystal panel by using the same pressurization defoaming unit.

In an embodiment, the polarizer attaching quality detection system can further include a cleaning unit connected to the conveyor line and configured to clean the polarizer.

In an embodiment, a material of the polarizer may be any one selected from a group consisting of an iodine polarizing material, a dye polarizing material, and a metal polarizing material.

In an embodiment, a material of the polarizer may be polyvinyl alcohol.

Referring to FIG. 2 and FIG. 3, in an embodiment of this application, a polarizer attaching quality detection method of this application includes: S200: providing liquid crystal panel; S210: before a step of attaching a polarizer to a surface of the liquid crystal panel, cleaning the polarizer; S220: attaching the polarizer to the surface of the liquid crystal panel; S230: pressurizing the attached polarizer on the surface of the liquid crystal panel by using a pressurization defoaming unit; S240: detecting whether the polarizer is closely attached to the surface of the liquid crystal panel; S250: determining whether the polarizer satisfies product specifications; S260: when the polarizer is closely attached to the surface of the liquid crystal panel, performing a packaging and delivering process; S270: when the polarizer is not closely attached to the surface of the liquid crystal panel, re-attaching the polarizer to the surface of the liquid crystal panel; and S280: pressurizing the re-attached polarizer on the surface of the liquid crystal panel by using the same pressurization defoaming unit.

In an embodiment, the step (S280) of pressurizing the re-attached polarizer on the surface of the liquid crystal panel by using the same pressurization defoaming unit can include: S310: performing a manual feeding step; S330: pressurizing and defoaming the polarizer; and S350: performing a manual discharging step.

In an embodiment, the step (S230) of pressurizing the attached polarizer on the surface of the liquid crystal panel by using the pressurization defoaming unit can include: performing an automatic feeding step; pressurizing and defoaming the polarizer; and performing an automatic discharging step.

In an embodiment, a product ledger material increased with the re-attachment of the polarizer to the surface of the liquid crystal panel needs to undergo a data comparison with a database.

In an embodiment, a polarizer attaching quality detection system may include an attaching unit, a pressurization defoaming unit, an attaching quality detection unit, a reprocessing attaching machine unit, and a conveyor line. The attaching unit is configured to attach a polarizer to a surface of a liquid crystal panel; the pressurization defoaming unit is configured to pressurize the polarizer attached by the attaching unit on the surface of the liquid crystal panel; the attaching quality detection unit is configured to detect whether the polarizer is closely attached to the surface of the liquid crystal panel; the reprocessing attaching machine unit is configured to: re-attach the polarizer to the surface of the liquid crystal panel when the polarizer is not closely attached to the surface of the liquid crystal panel; and the conveyor line is connected to the attaching unit, the pressurization defoaming unit, the attaching quality detection unit, and the reprocessing attaching machine unit and is configured to convey the polarizer and the liquid crystal panel, where the polarizer re-attached by the reprocessing attaching machine unit is pressurized on the surface of the liquid crystal panel by using the same pressurization defoaming unit.

In an embodiment, the polarizer attaching quality detection system can further include a cleaning unit connected to the conveyor line and configured to clean the polarizer.

In an embodiment, a material of the polarizer is any one selected from a group consisting of an iodine polarizing material, a dye polarizing material, and a metal polarizing material.

In an embodiment, a material of the polarizer may be polyvinyl alcohol.

Referring to FIG. 2 and FIG. 3, in an embodiment of this application, according to the polarizer attaching quality detection method of this application, the related step (S280) of pressurizing the re-attached polarizer on the surface of the liquid crystal panel includes: S310: manually feeding an abnormal polarizer at a port in a manual processing manner; S320: providing needed materials and feeding; S330: inserting the abnormal polarizer into a cavity for a pressurization defoarning manufacturing process; S340: discharging redundant materials; and S350: manually discharging the polarizer at a port in a manual processing manner.

In an embodiment, a material of the polarizer s any one selected from a group consisting of an iodine polarizing material, a dye polarizing material, and a metal polarizing material.

In an embodiment, a material of the polarizer may be polyvinyl alcohol.

In an embodiment, a product ledger material increased with the re-attachment of the polarizer to the surface of the liquid crystal panel needs to undergo a data comparison with a database.

Referring to FIG. 2 and FIG. 3, in, an embodiment, according to the polarizer attaching quality detection method of this application, each manufacturing process layer may automatically adjust parameters such as a needed temperature, needed pressure, and a needed manufacturing time according to sizes of products.

In an embodiment, according to the polarizer attaching quality detection method of this application, for cluster type pressurization defoaming, after an input ledger material of a product is confirmed, a device may select the number of layers of a manufacturing process of the product according to the material read by the device.

In an embodiment, according to the polarizer attaching quality detection method of this application, an existing pressurization defoaming device may be used to increase manual feeding ports, and work with reference to an in-factory ledger material management system.

In this application, not only a polarizer re-processing flow can be effectively simplified, and ledger materials of re-processed products are easily and systematically managed, but also investment costs of devices are reduced.

Terms such as “in some embodiments” and “in various embodiments” are repeatedly used. Usually, the terms do not refer to a same embodiment; but they may also refer to a same embodiment. Words such as “comprise”, “have”, “include” are synonyms, unless other meanings are indicated in the context.

The foregoing descriptions are merely preferred embodiments of this application, and are not intended to limit this application in any form. Although this application has been disclosed above through the preferred embodiments, the embodiments are not intended to limit this application. Any person skilled in the art can make some equivalent variations or modifications according to the foregoing disclosed technical content without departing from the scope of the technical solutions of this application to obtain equivalent embodiments. Any simple amendment, equivalent change or modification made to the foregoing embodiments according to the technical essence of this application without departing from the content of the technical solutions of this application shall fall within the scope of the technical solutions of this application.

What is claimed is:

1. A polarizer attaching quality detection system, comprising:
an attaching unit, configured to attach a polarizer to a surface of a liquid crystal panel;
a pressurization defoaming unit, configured to pressurize the polarizer attached by the attaching unit on the surface of the liquid crystal panel;
an attaching quality detection unit, configured to detect whether the polarizer is closely attached to the surface of the liquid crystal panel;
a reprocessing attaching machine unit, configured to re-attach the polarizer to the surface of the liquid crystal panel when the polarizer is not closely attached to the surface of the liquid crystal panel when the polarizer is not closely attached to the surface of the liquid crystal panel; and
a conveyor line, connected to the attaching unit, the pressurization defoaming unit, the attaching quality detection unit, and the reprocessing attaching machine unit, wherein the conveyor line is configured to convey the polarizer and the liquid crystal panel;
wherein the polarizer re-attached by the reprocessing attaching machine unit is pressurized on the surface of the liquid crystal panel by using the same pressurization defoaming unit.

2. The polarizer attaching quality detection system according to claim 1, further comprising a cleaning unit connected to the conveyor line and configured to clean the polarizer.

3. The polarizer attaching quality detection system according to claim 1, wherein a material of the polarizer comprises an iodine polarizing material.

4. The polarizer attaching quality detection system according to claim 1, wherein a material of the polarizer comprises a dye polarizing material.

5. The polarizer attaching quality detection system according to claim 1, wherein a material of the polarizer comprises a metal polarizing material.

6. The polarizer attaching quality detection system according to claim 1, wherein a material of the polarizer comprises polyvinyl alcohol.

7. A polarizer attaching quality detection method, comprising:
attaching a polarizer to a surface of a liquid crystal panel;
pressurizing the attached polarizer on the surface of the liquid crystal panel by using a pressurization defoaming unit;
detecting whether the polarizer is closely attached to the surface of the liquid crystal panel, and when the polarizer is not closely attached to the surface of the liquid crystal panel, re-attaching the polarizer to the surface of the liquid crystal panel; and
pressurizing the re-attached polarizer on the surface of the liquid crystal panel by using the same pressurization defoaming unit.

8. The polarizer attaching quality detection method according to claim 7, wherein the step of detecting whether the polarizer is closely attached to the surface of the liquid crystal panel comprises: when the polarizer is closely attached to the surface of the liquid crystal panel, performing a packaging and delivering process.

9. The polarizer attaching quality detection method according to claim 7, further comprising: before the step of attaching a polarizer to a surface of a liquid crystal panel, cleaning the polarizer.

10. The polarizer attaching quality detection method according to claim 7, wherein the step of pressurizing the re-attached polarizer on the surface of the liquid crystal panel by using the same pressurization defoaming unit comprises: performing a manual feeding step, pressurizing and defoaming the polarizer, and performing a manual discharging step.

11. The polarizer attaching quality detection method according to claim 7, wherein the step of pressurizing the attached polarizer on the surface of the liquid crystal panel by using they pressurization defoaming unit comprises: performing an automatic feeding step, pressurizing and defoaming the polarizer, and performing an automatic discharging step.

12. The polarizer attaching quality detection method according to claim 7, wherein a product ledger material increased with the re-attachment of the polarizer to the surface of the liquid crystal panel needs to undergo a data comparison with a database.

13. The polarizer attaching quality detection system according to claim 7, wherein a material of the polarizer comprises an iodine polarizing material.

14. The polarizer attaching quality detection system according to claim 7, wherein a material of the polarizer comprises a dye polarizing material,

15. The polarizer attaching quality detection system according to claim 7, wherein a material of the polarizer comprises a metal polarizing material.

16. The polarizer attaching quality detection system according to claim 7, wherein a material of the polarizer comprises polyvinyl alcohol.

17. A polarizer attaching quality detection system, comprising:
an attaching unit, configured to attach a polarizer to a surface of a liquid crystal panel;
a pressurization defoaming unit, configured to pressurize the, polarizer attached by the attaching unit to the surface of the liquid crystal panel;
an attaching quality detection unit, configured to detect whether the polarizer is closely attached to the surface of the liquid crystal panel;
a reprocessing attaching machine unit, configured to: re-attach the polarizer to the surface of the liquid crystal panel when the polarizer is not closely attached to the surface of the liquid crystal panel; and
a conveyor line, connected to the attaching unit, the pressurization defoaming unit, the attaching quality detection unit, and the reprocessing attaching machine unit, wherein the conveyor line is configured to convey the polarizer and the liquid crystal panel, and
a cleaning unit, connected to the conveyor line, and configured to clean the polarizer, wherein
the polarizer re-attached by the reprocessing attaching machine unit is pressurized on the surface of the liquid crystal panel by using the same pressurization defoaming unit; and
a material of the polarizer is any one selected from a group consisting of an iodine polarizing material, a dye polarizing material, a metal polarizing material, and polyvinyl alcohol.
